(19) United States
(12) Patent Application Publication
(10) Pub. No.: US 2022/0200048 A1
(43) Pub. Date: Jun. 23, 2022

(54) ION CONDUCTOR WITH HIGH ROOM-TEMPERATURE IONIC CONDUCTIVITY AND PREPARATION METHOD THEREOF

(71) Applicant: Zhejiang University, Hangzhou (CN)

(72) Inventors: Yinzhu Jiang, Hangzhou (CN); Wenhao Guan, Hangzhou (CN)

(21) Appl. No.: 17/691,360

(22) Filed: Mar. 10, 2022

Related U.S. Application Data
(63) Continuation-in-part of application No. PCT/CN2019/107489, filed on Sep. 24, 2019.

(30) Foreign Application Priority Data
Sep. 11, 2019 (CN) 201910858906.X

(51) Int. Cl. H01M 10/0562; C01B 33/46

(52) U.S. Cl. CPC H01M 10/0562; C01B 33/46; H01M 2300/0068; C01P 2004/03; C01P 2002/02; C01P 2002/72; C01P 2006/40

(57) ABSTRACT

The present disclosure discloses an ion conductor with high room-temperature ionic conductivity and a preparation method thereof. This method employs solid-phase sintering and ion exchange technologies, and can prepare crystalline and amorphous transition metal silicate by adjusting the addition ratio of sodium source. The chemical formula of the prepared transition metal silicate is A₂₋₂ₓMSiO₄₋ₓ, wherein A is Na, Li, Mg, Ca, or Zn; M is a transition metal Fe, Cr, Mn, Co, V, or Ni, when 0<x≤0.5, the prepared transition metal silicate is crystalline, and the degree of crystallization decreases as x increases; and when 0.5<x<1, the transition metal silicate is amorphous.

### Cross-reference to Related Application

The present application is a continuation-in-part application of PCT International application with the filing No. PCT/CN2019/107489, filed on Sep. 24, 2019, and the preceding PCT international application claims the priority to the Chinese patent application with the filing number 201910858906.X, filed on Sep. 11, 2019 with the Chinese Patent Office, and entitled “Sodium Ion Conductor with High Room-temperature Ionic Conductivity and Preparation Method therefor”, the contents of which are incorporated herein by reference in entirety.

### TECHNICAL FIELD

The present disclosure relates to the technical field of secondary batteries, and in particular, to an ion conductor with high ionic conductivity and a preparation method thereof.

### BACKGROUND ART

In recent years. as a suitable high-efficiency green-energy storage technology has not been developed, the energy shortage has become a global hot topic. Although the lithium ion battery temporarily dominates the new energy market at present by virtue of the comprehensive performance advantages, the lithium resources are quite limited, and the lithium ion battery cannot satisfy people's strong demand for sustainable development of the secondary energy industry. Exploring other high-performance metal ion batteries can compensate for the shortcomings of lithium resource lack. However, current metal secondary batteries mainly use toxic liquid electrolyte, which not only limits the increase of the energy density of the batteries, but also may bring severe safety hazards such as battery burning, leakage, expansion and explosion.

Exploiting all-solid-state metal ion batteries is an efficient way to increase the energy density and solve the safety problem. The solid-state battery uses a solid-state electrolyte that can conduct ions to replace the organic electrolyte. Compared with the liquid electrolyte, the solid-state electrolyte is usually a dense material, which can be miniaturized and thinned more easily, and therefore for the whole solid-state battery, it is easier to improve both mass and volumetric energy density. More importantly, using the solid-state electrolyte for the batteries can suppress the growth of the metal anode dendrites and further prevent the short circuit of the battery, and meanwhile, the solid is usually non-flammable and non-inflatable and does not react to release heat, therefore, using the all-solid-state battery can realize better safety.

From the above discussion, it can be seen that the development of all-solid-state battery relies on the development of high-performance and high-safety solid-state electrolyte, wherein the room-temperature ionic conductivity is a key parameter for evaluating the performance of the solid-state electrolyte, and the stability of solid-state electrolyte to air. temperature and metal anode determines the safety characteristics. Although long-term, extensive researches have been devoted, there is still no material that can balance performance and safety currently. An earlier developed polymer solid-state electrolyte can be better matched with the metal sodium anode due to the natural flexibility of polymer, and has outstanding performance in inhibiting dendrite growth; but the ion conduction in the polymer material completely depends on the wriggle of polymer segment, which belongs to a structure-driven material. However, the slow structure relaxation process of polymer and the resultant friction action severely restrict the ion diffusion, which restricts the increase of the room-temperature ionic conductivity of the polymer electrolyte, and cannot meet the practical application. Although the polymer undergoes inorganic salt doping, it is still difficult to completely release conductive ions from the coupling effect of structure. In addition, the ionic conductivity of the polymer electrolyte exhibits temperature sensitivity, and the polymer electrolyte generally can have good ionic conduction performance only at high temperatures (higher than 60° C.), which has greater limitation on the use environment of the battery. Currently, the strategy of improving the room-temperature ionic conductivity of the polymer solid-state electrolyte is mainly focused on reducing the coupling effect of segments on diffusion ions by cleaving polymer long chains by compounding inorganic material, and meanwhile reducing the glass transition temperature of polymer to improve the mobility of segments.

If the diffusion ions are completely released from the coupling of structure, another type of solid-state electrolyte-defect-driven ion conductor is involved. Such type of material is mainly an inorganic crystal material, and the structure has a diffusion channel penetrating through the frame. The diffusion of ions in the channel is driven by the migration of thermal defects in loaded ion sublattice, and the diffusion activation energy is generally low, therefore, a higher room-temperature ionic conductivity is provided compared with the structure-driven ion conductor. Although a stable structural framework constitutes an ion diffusion channel, the widespread grain boundaries are also introduced into the structure, which severely hinders the diffusion of ions between the grains, then it is critical to regulate the grain boundaries. There is a lattice mismatch problem between the fixed lattice of the electrolyte and the crystalline-state electrode material, which will lead to high interface impedance. Moreover, ion diffusion completely depends on the concentration and distribution of thermal defects, meaning that a part of the activation energy is required to create thermal defects, but the thermal defects are generally difficult to regulate, which challenges further improvement in the ionic conductivity of the defect-driven material.

### SUMMARY

A preparation method of a transition metal silicate ion conductor with high ionic conductivity, which is sintered by a solid phase method, specifically including the following steps:

### 1) Preparing a Precursor

preparing a precursor with a transition metal salt, a sodium salt, and ethyl orthosilicate as raw materials, wherein the molar ratio of sodium atoms in the sodium salt to metal atoms in the transition metal salt does not exceed 2, and the molar ratio of sodium atoms in the sodium salt to silicon atoms in the ethyl orthosilicate does not exceed 2; and the preparation of the precursor may adopt a conventional method such as a ball milling method and a sol-gel method;

### 2) Sintering

transferring the precursor into a porcelain boat, and pre-sintering at 300˜500° C. for more than 5 hours in a vacuum tubular furnace with inert gas protected; milling the resultant to refine powder particles; weighing and tableting the powder, wherein the pressure applied is not greater than 100 MPa, and the pressure is maintained for 3˜5 minutes, to obtain a precursor sheet with a thickness not more than 3 mm; transferring the precursor sheet into the porcelain boat, and finally sintering in the vacuum tubular furnace protected by an inert gas at a sintering temperature of 500˜900° C. for more than 8 hours, wherein the heating and cooling rates do not exceed 2° C. per minute, so as to obtain the crystalline or amorphous transition metal silicate sodium ion conductor with high ionic conductivity; and

### 3) Performing Ion Exchange

adopting an ion exchange method for the obtained transition metal silicate sodium ion conductor makes it possible for Na in the material to be replaced with other metal ions for other alkali metal or alkaline earth metal ion conductors, wherein the ion exchange can be achieved by electrochemical exchange, molten salt exchange, and solution exchange. The electrochemical exchange refers to charging or discharging the obtained sodium ion conductor with different metal anode, so that other metal ions replace Na sites; the molten salt exchange refers to immersing the obtained sodium ion conductor into a molten salt containing different metal ions, carrying out ion exchange with different chemical potentials; and the solution exchange method refers to immersing the obtained sodium ion conductor into a solution of different metal ions, and carrying out ion exchange by concentration differences.

An amorphous transition metal silicate, prepared by the preceding method, and having a chemical formula A₂₋₂ₓMSiO₄₋ₓ, wherein A is Na, Li, Mg, Ca or Zn; M is Fe, Cr, Mn, Co, V or Ni, 0.5<x<1.

A crystalline transition metal silicate, prepared by the preceding method, and having a chemical formula A₂₋₂ₓMSiO₄₋ₓ, wherein A is Na, Li, Mg, Ca or Zn; M is Fe, Cr, Mn, Co, V or Ni, 0<x≤0.5.

An ion conductor with high ionic conductivity, using the preceding amorphous transition metal silicate as a fast ion conductor for a solid-state electrolyte of a metal ion battery, wherein the ionic conductivity thereof reaches the order of 10⁻² S cm⁻¹.

An ion conductor with high ionic conductivity, using the preceding crystalline transition metal silicate as a fast ion conductor for a solid-state electrolyte of a metal ion battery, wherein the ionic conductivity thereof reaches the order of 10 S cm⁻¹.

### BRIEF DESCRIPTION OF DRAWINGS

FIG. 1 is an X-ray diffraction spectrum of sodium ferric silicate prepared in Embodiments 1 and 3.

FIG. 2 shows scanning electron micrographs of section of a sodium ferric silicate ceramic sheet prepared in Embodiments 1 and 3, where a is a crystalline sample, and b is an amorphous sample.

FIG. 3 is an X-ray diffraction spectrum of sodium manganese silicate prepared in Embodiments 4 and 5.

FIG. 4 is an X-ray diffraction spectrum of amorphous lithium ferric silicate prepared in Embodiment 6.

FIG. 5 is an alternating current impedance spectrum of crystalline sodium ferric silicate prepared in Embodiment 1.

FIG. 6 is an alternating current impedance spectrum of crystalline sodium ferric silicate prepared in Embodiment 2.

FIG. 7 is an alternating current impedance spectrum of amorphous sodium ferric silicate prepared in Embodiment 3.

FIG. 8 is a cycling curve of symmetric battery of sodium ferric silicate and metal sodium prepared in Embodiment 3.

FIG. 9 is a charge/discharge curve of an amorphous sodium ferric silicate prepared in Embodiment 3 used as a solid-state electrolyte of a sodium ion battery with sodium vanadium phosphate as cathode and metal sodium anode.

### DETAILED DESCRIPTION OF EMBODIMENTS

In order to make the objectives, technical solutions, and advantages of the embodiments of the present disclosure clearer, the technical solutions in the embodiments of the present disclosure will be described below clearly and completely. If no specific conditions are specified in the embodiments, they are carried out under normal conditions or conditions recommended by manufacturers. If manufacturers of reagents or apparatuses used are not specified, they are conventional products commercially available.

The technical problem to be solved by the present disclosure includes, for example, providing a novel ion conductor with high ionic conductivity in order to further improve the room-temperature ionic conductivity of the ion conductor, wherein the material is an ion conductor having an ultra-high room-temperature ionic conductivity, an extremely low electron conductivity, and meanwhile high safety, and the present disclosure further provides a preparation method thereof and use in all-solid-state batteries.

Based on the above objective, a technical solution of the present disclosure is as follows.

A preparation method of a transition metal silicate ion conductor with high ionic conductivity, which is sintered by a solid phase method, specifically including the following steps:

1) Preparing a Precursor preparing a precursor with a transition metal salt, a sodium salt, and ethyl orthosilicate as raw materials, wherein the molar ratio of sodium atoms in the sodium salt to metal atoms in the transition metal salt does not exceed 2, and the molar ratio of sodium atoms in the sodium salt to silicon atoms in the ethyl orthosilicate does not exceed 2; and the preparation of the precursor may adopt a conventional method such as a ball milling method and a sol-gel method;

### 2) Sintering

transferring the precursor into a porcelain boat, and pre-sintering at 300-500° C. for more than 5 hours in a vacuum tubular furnace with inert gas protected; milling the resultant to refine powder particles; weighing and tableting the powder, wherein the pressure applied is not greater than 100 MPa, with maintaining the pressure for 3-5 minutes, to obtain a precursor sheet with thickness not more than 3 mm; transferring the precursor sheet into the porcelain boat, and finally sintering in the vacuum tubular furnace protected by an inert gas at a sintering temperature of 500-900° C. for more than 8 hours, wherein the heating and cooling rates do not exceed 2° C. per minute. so as to obtain the crystalline or amorphous transition metal silicate sodium ion conductor with high ionic conductivity; and

### 3) Ion Exchange

adopting an ion exchange method for the obtained transition metal silicate sodium ion conductor makes it possible for Na in the material can be replaced with other metal ions for other alkali metal or alkaline earth metal ion conductors. The ion exchange can be achieved by electrochemical exchange, molten salt exchange, and solution exchange, wherein the electrochemical exchange refers to charging or discharging the obtained sodium ion conductor with different metal anode, so that other metal ions replace Na sites; the molten salt exchange refers to immersing the obtained sodium ion conductor into a molten salt containing different metal ions, carrying out ion exchange with different chemical potentials; and the solution exchange method refers to immersing the obtained sodium ion conductor into a solution of different metal ions, and carrying out ion exchange by concentration differences. Optionally, the transition metal in the transition metal salt is one of Fe, Cr, Mn, Co, V or Ni, and the transition metal salt refers to acetate, oxalate, nitrate or citrate.

Optionally, the sodium salt is sodium acetate or sodium citrate.

Optionally, in step 1), when the molar ratio of sodium atoms in the sodium salt to metal atoms in the transition metal salt is 1-2, the product is in a crystalline state, and when the molar ratio of sodium atoms in the sodium salt to metal atoms in the transition metal salt is less than 1. the product is in an amorphous state.

Optionally, in step 1), the molar ratio of sodium atoms in the sodium salt to metal atoms in the transition metal salt does not exceed 1, and is not less than 0.5.

Optionally, in step 1), the ratio of the mole number of metal atoms to the mole number of sodium atoms is 1:0.5-1:2.

Optionally, in step 1), the ratio of the mole number of silicon atoms to the mole number of sodium atoms is 1:0.5-1:2.

Notably, ratio ranges of the above ratio of the mole number of metal atoms to the mole number of sodium atoms and the ratio of the mole number of silicon atoms to the mole number of sodium atoms not only include the point values exemplified above, but also include any ratio in the above ratio ranges not exemplified, and any ratio in the above ratio ranges is covered in the scope of protection of the present disclosure.

Optionally, in step 2), the inert gas is argon or nitrogen.

Notably, apart from argon and nitrogen, the above inert gas also may be other inert gases as long as the inert gases can be used as a protective atmosphere.

Optionally, in step 2), the pre-sintering temperature is 300° C., 350° C., 400° C., 450° C. or 500 ° C.

Optionally, in step (2), the sintering temperature is 500° C., 550° C,, 600° C., 650° C., 700° C., 750° C., 800° C., 850° C., or 900 ° C.

Notably, the numerical ranges of the above pre-sintering temperatures and the sintering temperatures not only include the point values exemplified above, but also include any numerical values in the above numerical ranges not exemplified, and any numerical value in the above numerical ranges is covered in the scope of protection of the present disclosure.

Optionally, other metal ions in step 3) are one of Li, Mg, Ca or Zn.

Optionally, the molten salt in step 3) refers to a salt capable of dissociating desired metal ions in the molten state.

Optionally, the solution in step 3) is a solution capable of ionizing desired metal ions in a solvent.

An amorphous transition metal silicate, prepared by the foregoing method, and having a chemical formula A₂₋₂ₓMSiO₄₋ₓ, wherein A is Na, Li, Mg, Ca or Zn; M is Fe, Cr, Mn, Co, V or Ni, 0.5<x<1.

A crystalline transition metal silicate, prepared by the foregoing method, and having a chemical formula A₂₋₂ₓMSiO₄₋ₓ, wherein A is Na, Li, Mg, Ca or Zn; M is Fe, Cr, Mn, Co, V or Ni, 0<x≤0.5.

An ion conductor with high ionic conductivity, using the preceding amorphous transition metal silicate as a fast ion conductor for a solid-state electrolyte of a metal ion battery, wherein the ionic conductivity thereof reaches the order of 10⁻² S/cm⁻¹.

An ion conductor with high ionic conductivity, using the preceding crystalline transition metal silicate as a fast ion conductor for a solid-state electrolyte of a metal ion battery, wherein the ionic conductivity thereof reaches the order of 10⁻³ S cm⁻¹.

The transition metal silicate prepared by the method of the present disclosure, whether crystalline or amorphous, can be used as an ion conductor for a solid-state electrolyte, and the transition metal silicate belongs to a polyanionic compound, and the Si—O strong covalent bond enables a stable framework structure in a crystalline structure. As the silicate group can only provide a weaker induction effect on the transition metal ions, the form of bonding between the transition metal and oxygen is more inclined to the covalent bond. the transition metal and silicon are alternately arranged to form a structural framework, and the ions can be diffused freely in the channel. Meanwhile, due to the barrier of silicon, there is no smooth electron diffusion path in the structure, so that the transition metal silicate has a very low electron conductivity, and when used as a solid-state electrolyte, direct growth of dendrites inside the bulk phase can be suppressed.

In the above process of preparing the precursor, the addition amount of sodium salt is quite critical. When the molar ratio of sodium atoms in the sodium salt to metal atoms in the transition metal salt is 1-2, the product is in a crystalline state, and when the molar ratio of sodium atoms in the sodium salt to metal atoms in the transition metal salt is lower than 1, the product is in an amorphous state. In addition, it is determined through theoretical speculation and repeated test verification that to enable the performance of product to be optimized, the addition amount of sodium salt should satisfy that the molar ratio of the sodium atoms therein to the metal atoms in the transition metal salt does not exceed 1 and is not lower than 0.5; when the sodium salt is added too little, the concentration of the diffusion ions of the product is too low, the defect concentration is too high, and the ionic conductivity of the transition metal silicate cannot be greatly improved; when the addition amount of sodium salt is too high, the formation energy of the silicate will be reduced, a part of the raw materials react to form a crystalline transition metal silicate, and a grain boundary is introduced therein, thus directly influencing the ionic conductivity of the product.

Although the crystalline transition metal silicate prepared by the present disclosure has the room-temperature ionic conductivity that can reach the order of 10⁻³ S/cm, it still belongs to a defect-driven ion conductor, and lacks a structural driving force. and it is difficult for the room-temperature ionic conductivity to further increase under crystallization conditions. If the addition ratio of the sodium source is decreased when preparing the material precursor, the transition metal silicate can be gradually amorphized under the same sintering conditions due to the improvement of the material formation energy. Such amorphization is manifested by changes in the bond length of silicon-oxygen bonds and metal-oxygen bonds, so that the structural framework of the material is distorted, and loses long-range order. This means that the framework of material also has a relaxation degree of freedom, providing conditions for the coupling of the structure with the diffusion ions. However, the covalent bond property inside the framework is not changed, and the relaxation of the diffusion ion sublattice and the migration process of the thermal defect are not hindered, therefore, such amorphization can introduce a structural relaxation driving force into the defect-driven ion conductor, and promote ion diffusion. Meanwhile, the arnorphization of the material can also eliminate the grain boundary, and further improve the room-temperature ionic conductivity of the material, for example, the room-temperature ionic conductivity of amorphous sodium ferric silicate can reach 1.9×10⁻² S/cm. In addition, the transition metal silicate is stable to the air, and the elements involved are all inexpensive and easily available, which has a low synthetic cost and a great economic value, and is suitable for large-scale development and application of sodium ion batteries.

The preparation method of transition metal silicate provided by the present disclosure is simple and feasible, wherein a precursor is firstly prepared and then sintered by a solid phase method to obtain a dense transition metal silicate ceramic sheet. Particularly, in order to prepare the amorphous transition metal silicate, the material structure framework is enabled to obtain relaxation ability without damaging the covalent framework, and meanwhile movement of diffusion ions and thermal defect are not affected, a structural relaxation driving force is introduced into the defect-driven material, the advantages of two types of ion conductors are fully combined, and the room-temperature conductivity of the ion conductor is further improved. In the preparation process of the present disclosure, the preparation of the amorphous transition metal silicate is realized for the first time by selecting a suitable preparation method, adjusting the addition ratio of raw materials, and controlling the parameters of the phase-forming process, and the amorphization does not destroy the covalent properties of the silicate framework structure. First, in the process of preparing the precursor in the present disclosure, the formation energy of the transition metal silicate is increased by only reducing the addition ratio of sodium source, and the amorphization of the silicate material itself is realized without introducing other materials. Secondly, in the process of using the solid-phase sintering method, by reasonably selecting and controlling the process parameters, especially the heat treatment temperature and the heating and cooling rates, a high relative density of the finally prepared transition metal silicate ceramic sheet is ensured, without transition metal oxide impurities, and it is ensured that the polyanionic compound is formed and a stable covalent framework is retained. In the present preparation method. the amorphous transition metal silicate can be obtained in mild conditions at a low cost, without composite assistance.

The present disclosure further provides a transition metal silicate prepared according to the above preparation method, wherein a chemical formula thereof is A₂₋₂ₓMSiO₄₋ₓ, where A is Na, Li, Mg, Ca, or Zn; M is a transition metal Fe, Cr, Mn, Co, V, or Ni. when 0.5<x<1, the transition metal silicate is amorphous, and when 0<x≤0.5, the transition metal silicate is crystalline. The ionic conductivity manifested by the amorphous transition metal silicate prepared by the method in the present disclosure proves that the amorphization in the present disclosure effectively increases the actual room- temperature ionic conductivity of the transition metal silicate. For example, the crystalline Na₂FeSiO₄ prepared is used as the cathode material of the sodium ion battery, and the ionic conductivity at 25° C. is 5.1×10⁻⁴ S/cm; after the sodium content is reduced, the crystalline NaFeSiO_{3.5} room-temperature ionic conductivity reaches 1.0×10⁻³ S/cm, which is higher than that of the crystalline Na₂FeSiO₄; as the sodium content is further decreased. the amorphous Na_{0.5}FeSiO_{3.25} prepared serves as a electrolyte of sodium ion battery, and the room-temperature ionic conductivity is further improved, achieving 1.9×10⁻² S/cm. These data demonstrate that the amorphization in the present disclosure has the effect of increasing the ionic conductivity of the transition metal silicate, and the transition metal silicate as a solid-state electrolyte of a metal battery can exhibit excellent electrochemical performance.

The present disclosure is further illustrated below by specific embodiments, but it should be understood that these embodiments are merely for more detailed description and should not be construed as limiting the present disclosure in any form.

### EMBODIMENT 1

The transition metal silicate solid-state electrolyte prepared in the present embodiment is crystalline Na2FeSiO4, wherein an iron source selected is ferrous oxalate, and a specific method includes the following steps:

1) mixing ferrous oxalate, sodium acetate, and ethyl orthosilicate into the same ball mill tank, adding 100 mL of anhydrous ethanol as a ball milling auxiliary, and ball milling the resultant at a rotational speed of 400 r/min for 8 hours, to evenly mix all the raw materials, wherein in the mixture mole number of iron atoms: mole number of sodium atoms: mole number of silicon atoms=1:2:1;

2) transferring the mixture to an oven, and drying at 80° C. for 12 hours to obtain a dried precursor;

3) placing the precursor in a clean porcelain boat, and pre-sintering the same in a vacuum tubular furnace with argon as a protective atmosphere at 350° C. for 2 hours;

4) continuing to ball mill the obtained powder material at a rotational speed of 400 r/min for 5 hours to obtain the powder material with uniformly dispersed particles;

5) weighing the powder material for tableting, with a pressure of 100 MPa being applied, and pressing the powder material into ceramic green body discs (round sheets) with a diameter of 1.2 cm; and

6) placing the ceramic green body in a clean porcelain boat, to be sintered in a vacuum tubular furnace with argon as a protective atmosphere at 500 ° C. for 10 hours to obtain a transition metal silicate—crystalline sodium ferric silicate sample.

### EMBODIMENT 2

The transition metal silicate solid-state electrolyte prepared in the present embodiment is crystalline NaFeSi3.5, wherein an iron source selected is ferric nitrate, and a specific method includes the following steps:

1) mixing ferric nitrate, sodium acetate, and ethyl orthosilicate in 100 mL of deionized water, ball milling the resultant at a rotational speed of 450 r/min for 12 hours, wherein in the mixed solution mole number of iron atoms: mole number of sodium atoms: mole number of silicon atoms=1:1:1;

2) transferring the mixture to an oven. and drying at 100° C. for 12 hours to obtain a dried precursor;

3) placing the precursor in a clean porcelain boat, and pre-sintering in a tubular furnace in nitrogen at 350 for 2 hours;

4) continuing to ball mill the obtained powder material at a rotational speed of 450 r/min for 5 hours to obtain a powder material with uniformly dispersed particles.

5) weighing the powder material for tableting, with a pressure of 100 MPa being applied, and pressing the powder material into ceramic green body discs with a diameter of 1.2 cm; and

6) placing the ceramic green body in a clean porcelain boat, to be sintered in a muffle furnace in air at 550° C. for 10 hours to obtain a transition metal silicate—NaFeSiO_{3.5} sample.

### EMBODIMENT 3

The transition metal silicate solid-state electrolyte prepared in the present embodiment is amorphous Na_{0.5}FeSiO_{3.25}, wherein an iron source selected is ferric nitrate, and a specific method includes the following steps:

1) mixing ferric nitrate and sodium acetate in 60 mL of deionized water, and magnetically stirring the resultant at 50° C., so as to uniformly mix all the raw materials in the solution, wherein in the solution mole number of iron atoms: mole number of sodium atoms=1:0.5;

2) adding a certain amount of glacial acetic acid dropwise, to adjust the pH value of the solution to below 6:

3) adding ethyl orthosilicate dropwise, to obtain mole number of iron atoms: mole number of sodium atoms: mole number of silicon atoms=1:0.5:1 in the mixed liquid, and continuing to stir at 50° C. to form homogeneous transparent sol;

4) heating to 90 ° C. and slowly evaporating the solvent to obtain a homogeneous translucent wet gel;

5) placing the wet gel in a drying box, and opening the container, for drying at 80° C. for 12 hours to obtain a homogeneous precursor xerogel;

6) placing the precursor in a clean porcelain boat, and pre-sintering in a tubular furnace in an inert gas at 400° C. for 2 hours;

7) ball milling the obtained powder material, at a rotational speed of 450 r/min for 5 hours to obtain a powder material with uniformly dispersed particles;

8) weighing the powder material for tableting, with a pressure of 100 MPa being applied, and pressing the powder material into ceramic green body discs with a diameter of 1.2 cm; and

9) placing the ceramic green body in a clean porcelain boat, to be sintered in a tubular furnace in an inert gas at 600° C. for 10 hours to obtain a transition metal silicate—amorphous sodium ferric silicate sample.

### EMBODIMENT 4

The transition metal silicate solid-state electrolyte prepared in the present embodiment is Na₂MnSiO₄, wherein a manganese source selected is manganese acetate, and a specific method includes the following steps:

1) mixing manganese acetate, sodium acetate, and ethyl orthosilicate into the same ball-milling tank, adding 100 of anhydrous ethanol as a ball milling auxiliary, and ball milling the resultant at a rotational speed of 400 r/min for 12 hours, to evenly mix all the raw materials, wherein in the mixture mole number of manganese atoms: mole number of sodium atoms: mole number of silicon atoms=1:2:1;

2) transferring the mixture to an oven, and drying at 80° C. for 6 hours to obtain a dried precursor;

3) placing the precursor in a clean porcelain boat, and pre-sintering in a vacuum tubular furnace with argon as a protective atmosphere at 500° C. for 2 hours;

4) continuing to ball mill the obtained powder material at a rotational speed of 400 r/min for 6 hours to obtain the powder material with uniformly dispersed particles;

5) weighing the powder material for tableting, with a pressure of 100 MPa being applied, and pressing the powder material into ceramic green body discs with a diameter of 1.2 cm; and

6) placing the ceramic green body in a clean porcelain boat, to be sintered in a vacuum tubular furnace with argon as a protective atmosphere at 800° C. for 10 hours to obtain a transition metal silicate—crystalline sodium manganese silicate sample.

### EMBODIMENT 5

The transition metal silicate solid-state electrolyte prepared in the present embodiment is Na_{0.5}MnSiO_{3.25}, wherein a manganese source selected is manganese acetate, and a specific method includes the following steps:

1) mixing manganese acetate, sodium acetate, and ethyl orthosilicate in 100 of deionized water, ball milling the mixture at a rotational speed of 450 r/min for 12 hours, wherein in the mixed solution mole number of manganese atoms: mole number of sodium atoms: mole number of silicon atoms=1:1:1;

2) transferring the mixture to an oven. and drying at 100° C. for 12 hours to obtain a dried precursor;

3) placing the precursor in a clean porcelain boat, and pre-sintering in a vacuum tubular furnace in argon at 500° C. for 2 hours;

4) continuing to ball mill the obtained powder material at a rotational speed of 450 r/min for 5 hours to obtain the powder material with uniformly dispersed particles;

5) weighing the powder material for tableting, with a pressure of 100 MPa being applied, and pressing the powder material into ceramic green body discs with a diameter of 1.2 cm; and 6) placing the ceramic green body in a clean porcelain boat, to be sintered in a vacuum tubular furnace in argon at 700° C. for 10 hours to obtain a transition metal silicate—amorphous sodium manganese silicate sample.

### EMBODIMENT 6

The transition metal silicate solid-state electrolyte prepared in the present embodiment is amorphous Li_{0.5}FeSiO_{3.25}, wherein amorphous Na_{0.5}FeSiO_{3.25} is selected, the ion exchange is performed by the electrochemical exchange method, and a specific method includes the following steps:

1) mixing ferric nitrate and sodium acetate in 60 mL of deionized water, magnetically stirring the resultant at 50° C., so as to uniformly mix all the raw materials in the solution, wherein in the solution mole number of iron atoms : mole number of sodium atoms=1:0.5;

2) adding a certain amount of glacial acetic acid dropwise, to adjust the pH value of the solution to below 6;

3) adding ethyl orthosilicate dropwise, to obtain mole number of iron atoms: mole number of sodium atoms: mole number of silicon atoms=1:0.5:1 in the mixed liquid, and continuing to stir at 50° C. to form homogeneous and transparent sol;

4) heating to 90° C. and slowly evaporating the solvent to obtain a homogeneous and translucent wet gel;

5) placing the wet gel in a drying box, and opening the container, for drying at 80° C. for 12 hours to obtain a homogeneous precursor xerogel;

6) placing the precursor in a clean porcelain boat, and pre-sintering in a tubular furnace in an inert gas at 400° C. for 2 hours;

7) ball milling the obtained powder material, at a rotational speed of 450 r/min for 5 hours to obtain a powder material with uniformly dispersed particles;

8) weighing the powder material for tableting, with a pressure of 100 MPa being applied, and pressing the powder material into ceramic green body discs with a diameter of 1.2 cm;

9) placing the ceramic green body in a clean porcelain boat, to be sintered in a tubular furnace in an inert gas at 600° C. for 10 hours to obtain an amorphous sodium ferric silicate sample; and

10) using the obtained amorphous sodium ferric silicate as a solid-state electrolyte, assembling a battery with an Li metal anode and a Cu cathode, discharging at a current density of 0.1 mA/cm2 for 40 h, and disassembling the battery, to obtain an amorphous lithium ferric silicate sample.

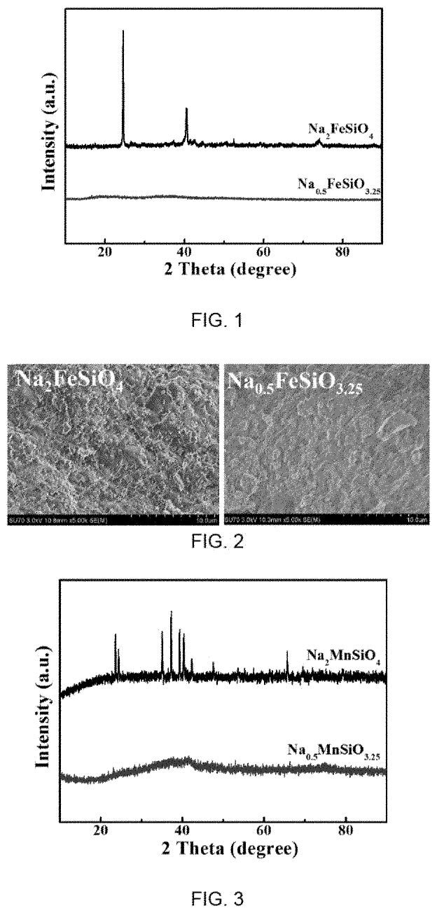

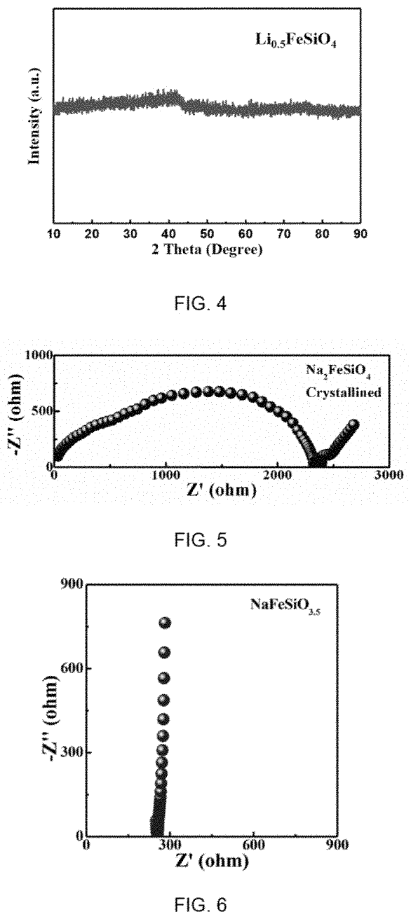

An XRD test and an SEM observation are performed on the transition metal silicate prepared above. FIG. 1 shows an X-ray diffraction (XRD) spectrum of sodium ferric silicate prepared in Embodiments 1 and 3. It can be seen from FIG. 1 that the obtained crystalline sodium ferric silicate is of a pure phase, and after the proportion of the sodium source is reduced, the amorphization of the sodium ferric silicate sample is realized; and FIG. 2 is a scanning electron micrographs (SEM) of a section of the sodium ferric silicate ceramic sheet prepared in Embodiments 1 and 3. It can be seen from the drawings that the sodium ferric silicate ceramic sheet prepared by this method does not have obvious pores and has a high density. The X-ray diffraction (XRD) spectrum of the sodium manganese silicate prepared in Embodiments 4 and 5 is shown in FIG. 3. XRD analysis: the sodium manganese silicate prepared by this method is of a pure phase, no impurity peak appears, and after the introduction amount of the sodium source is reduced, the amorphization of the sodium manganese silicate is also realized. The amorphization can introduce a structural driving force into the inorganic material, further promoting the ion diffusion and obtaining higher ionic conductivity. The X-ray diffraction (XRD) spectrum of the amorphous lithium ferric silicate prepared in Embodiment 6 is as shown in FIG. 4, the solid-state electrolyte after electrochemical exchange still maintains the amorphous structure, and the transition metal silicate material can be expanded into other solid-state ion battery systems.

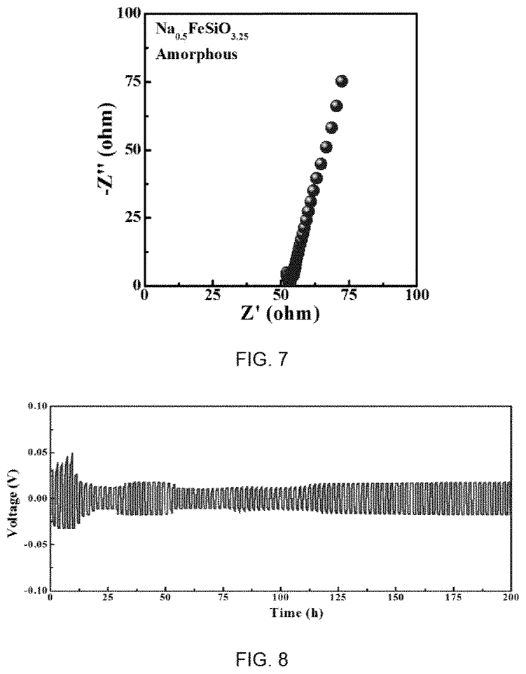

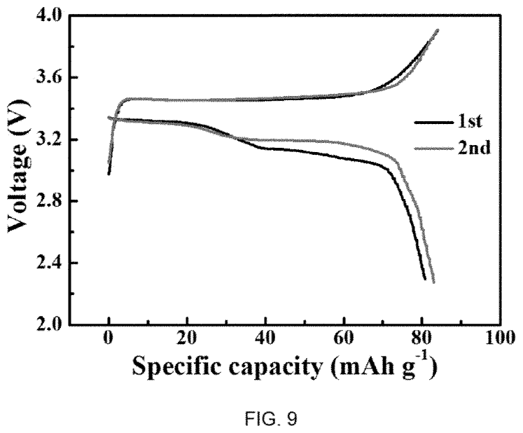

An electrochemical performance test is performed on the transition metal silicate prepared above. FIGS. 5, 6, and 7 are alternating current impedance spectrums of crystalline and amorphous sodium ferric silicate prepared in Embodiments 1, 2, and 3. It can be seen from FIG. 4 that the ionic conductivity of the crystalline sodium ferric silicate ceramic sheet at normal temperature is 5.1×10⁻⁴ S/cm. After amorphization (FIG. 7), the room-temperature ionic conductivity reaches 1.9×10⁻² S/cm, thereby achieving a large increase in the ionic conductivity, proving that the structural driving force introduced by amorphization proposed in the present disclosure can significantly improve the ionic conductivity of sodium ferric silicate as a solid-state electrolyte of sodium ion batteries, and meanwhile proving that sodium ferric silicate prepared by this method satisfies the performance requirements as a solid-state electrolyte of sodium ion battery. It can be seen from FIG. 8 that the symmetric battery assembled from the amorphous sodium ferric silicate ceramic sheet and sodium can be stably cycled at a current density of 1 mA/g for at least 200 hours, and has an overpotential lower than 40 mV, proving that this material as the solid-state electrolyte of sodium ion battery has excellent cycling stability, and meanwhile also proving that the amorphous sodium ferric silicate solid-state electrolyte has a unique advantage in inhibiting the growth of the sodium dendrites. FIG. 9 shows a solid-state battery assembled from the amorphous sodium ferric silicate prepared in Embodiment 3, sodium vanadium phosphate cathode and metal sodium anode, proving that the practical application of the amorphous sodium ferric silicate to the solid-state electrolyte of sodium ion battery exhibits excellent performance comparable to that of conventional liquid electrolyte.

The above embodiments are some of the detailed descriptions of the present disclosure, but researchers in the technical field of the present disclosure may make changes in form and content rather than substantive changes according to the above embodiments, without departing from the essential scope of protection of the present disclosure, and the synthetic process in the present disclosure is not limited to the specific forms and details in the embodiments.

### INDUSTRIAL APPLICABILITY

The preparation method of transition metal silicate provided by the present disclosure is simple and feasible, wherein a precursor is firstly prepared and then sintered by a solid phase method to obtain a dense transition metal silicate ceramic sheet. Particularly, in order to prepare the amorphous transition metal silicate, the material structure framework is enabled to obtain relaxation ability without damaging the covalent framework, and meanwhile movement of diffusion ions and thermal defect is not affected, a structural relaxation driving force is introduced into the defect-driven material, the advantages of two types of ion conductors are fully combined, and the room-temperature conductivity of the ion conductor is further improved. In the preparation process of the present disclosure, the preparation of the amorphous transition metal silicate is realized for the first time by selecting a suitable preparation method, adjusting the addition ratio of raw materials. and controlling the parameters of the phase-forming process, and the amorphization does not destroy the covalent properties of the silicate framework structure. First, in the process of preparing the precursor in the present disclosure, the formation energy of the transition metal silicate is increased by only reducing the addition ratio of sodium source, and the amorphization of the silicate material itself is realized without introducing other materials. Secondly, in the process of using the solid-phase sintering method, by reasonably selecting and controlling the process parameters. especially the heat treatment temperature and the heating and cooling rates, a high relative density of the finally prepared transition metal silicate ceramic sheet is ensured, without transition metal oxide impurities, and it is ensured that the polyanionic compound is formed and a stable covalent framework is retained.

Meanwhile, with a simple ion exchange method, the transition metal silicate having excellent ionic conductivity can be applied to other metal ion battery systems. In the present preparation method, the amorphous transition metal silicate can be obtained in mild conditions at a low cost, without composite assistance.

What is claimed is:

1. A preparation method of a transition metal silicate ion conductor with high ionic conductivity, wherein the preparation method is performed by sintering using a solid phase method, specifically comprising following steps:
1) preparing a precursor, comprising
preparing a precursor with a transition metal salt, a sodium salt, and ethyl orthosilicate as raw materials, wherein a molar ratio of sodium atoms in the sodium salt to metal atoms in the transition metal salt does not exceed 2, and a molar ratio of sodium atoms in the sodium salt to silicon atoms in the ethyl orthosilicate does not exceed 2;
2) making a solid phase sintered, comprising
transferring the precursor into a porcelain boat, and pre-sintering the precursor in a vacuum tubular furnace protected by an inert gas at 300˜500 ° C. for more than 5 hours; milling a resultant to refine powder particles; weighing and tableting powder, wherein a pressure applied is not greater than 100 MPa, and the pressure is maintained for 3˜5 minutes, to obtain a precursor sheet with a thickness not more than 3 mm; transferring the precursor sheet into a porcelain boat, and finally sintering the precursor sheet in the vacuum tubular furnace protected by an inert gas for more than 8 hours, at a sintering temperature of 500˜900° C., wherein the heating and cooling rates do not exceed 2° C. per minute, so as to obtain a crystalline or amorphous transition metal silicate sodium ion conductor with high ionic conductivity; and
3) performing ion exchange, comprising
using an ion exchange method to replace Na in an obtained transition metal silicate sodium ion conductor with other metal ions, so as to prepare other alkali metal or alkaline earth metal ion conductors, wherein ion exchange can be performed by a method comprising electrochemical exchange, molten salt exchange, and solution exchange, wherein the electrochemical exchange is achieved by charging or discharging the obtained sodium ion conductor with different metal anodes, so that other metal ions replace Na sites; the molten salt exchange is achieved by to immersing the obtained sodium ion conductor into a molten salt containing different metal ions, and carrying out ion exchange with different chemical potentials; and the solution exchange method comprises immersing the obtained sodium ion conductor into a solution of different metal ions, and carrying out ion exchange by concentration differences.

2. The preparation method of a transition metal silicate ion conductor with high ionic conductivity according to claim 1, wherein the transition metal salt is acetate, oxalate, or nitrate of any one of Fe, Cr, Mn, Co, V and Ni.

3. The preparation method of a transition metal silicate ion conductor with high ionic conductivity according to claim 1, wherein the sodium salt is sodium acetate, sodium nitrate or sodium citrate.

4. The preparation method of a transition metal silicate ion conductor with high ionic conductivity according to claim 1, wherein in step 1), when the molar ratio of sodium atoms in the sodium salt to metal atoms in the transition metal salt is 1˜2, a product is in a crystalline state. and when the molar ratio of sodium atoms in the sodium salt to metal atoms in the transition metal salt is less than 1, a product is in an amorphous state.

5. The preparation method of a transition metal silicate ion conductor with high ionic conductivity according to claim 1, wherein in step 1), the molar ratio of sodium atoms in the sodium salt to metal atoms in the transition metal salt does not exceed 1, and is not less than 0.5.

6. The preparation method of a transition metal silicate ion conductor with high ionic conductivity according to claim 1, wherein in step 1), a ratio of a mole number of metal atoms to a mole number of sodium atoms is 1:0.5-1:2.

7. The preparation method of a transition metal silicate ion conductor with high ionic conductivity according to claim 1, wherein in step 1), a ratio of a mole number of silicon atoms to a mole number of sodium atoms is 1:0.5-1:2.

8. The preparation method of a transition metal silicate ion conductor with high ionic conductivity according to claim 1, wherein in step 2), the inert gas is argon or nitrogen.

9. The preparation method of a transition metal silicate ion conductor with high ionic conductivity according to claim 1, wherein in step 2), a pre-sintering temperature is 300° C., 350° C., 400° C., 450° C. or 500 ° C.

10. The preparation method of a transition metal silicate ion conductor with high ionic conductivity according to claim 1, wherein in step 2), the sintering temperature is 500° C., 550° C., 600° C., 650° C., 700° C., 750° C., 800° C., 850° C., or 900° C.

11. The preparation method of a transition metal silicate ion conductor with high ionic conductivity according to claim 1, wherein other metal ions in step 3) are one of Li, Mg, Ca or Zn.

12. The preparation method of a transition metal silicate ion conductor with high ionic conductivity according to claim 1, wherein the molten salt in step 3) is a salt capable of dissociating desired metal ions in a molten state.

13. The preparation method of a transition metal silicate ion conductor with high ionic conductivity according to claim 1, wherein the solution in step 3) is a solution capable of ionizing desired metal ions in a solvent.

14. An amorphous transition metal silicate, prepared by the method according to claim 1, and having a chemical formula A₂₋₂ₓMSiO₄₋ₓ, wherein A is Na, Li, Mg, Ca or Zn; M is Fe, Cr, Mn, Co, V or Ni, and 0.5<x<1.

15. A crystalline transition metal silicate, prepared by the method according to claim 1, and having a chemical formula A₂₋₂ₓMSiO₄₋ₓ, wherein A is Na, Li, Mg, Ca or Zn; M is Fe, Cr, Mn, Co, V or Ni, and 0<x≤0.5.
